(19) United States
(12) Patent Application Publication
(10) Pub. No.: US 2004/0218549 A1
(43) Pub. Date: Nov. 4, 2004

(54) Method and system for network device upgrade

(75) Inventor: Tsung-Hsing Chen, Gueishan Township (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/824,570

(22) Filed: Apr. 13, 2004

(30) Foreign Application Priority Data
Apr. 14, 2003 (TW) 92108521

(51) Int. Cl. H04L 12/28

(52) U.S. Cl. 370/254

(57) ABSTRACT

A system for network device upgrade. A computer system outputs a first packet and a second packet. The first packet comprises at least version identification for upgrade data. The second packet comprises at least the upgrade data. A switching device is connected the computer system. A plurality of network devices is connected to the switching device to receive the first and second packets, and receives the first package to generate non-repetitive IP addresses corresponding to the computer system, selectively generating an upgrade request according to the version identification data in the first packet and outputting the request to the computer system.

### BACKGROUND OF THE INVENTION

1. Field of the Invention

The present invention relates to networks, and in particular to a method and system using a computer system to upgrade network devices.

2. Description of the Related Art

Asymmetric digital subscriber line (ADSL) modem technology converts existing twisted-pair telephone lines into access paths for high-speed communications. ADSL modems transmit up to 1.5 Mbps upstream, and in interactive mode 640 kbps in both directions, increasing access capacity from 5.6 k modem technology.

To increase ADSL modem speed, ADSL firmware must be upgraded. ADSL modems often have unique setup parameters, compared to existing environments. When ADSL modems undergo firmware upgrades, subnet mask and IP address changes to the ADSL modems cause problems when the upgrade computer system has different settings than the ADSL modem. Thus, ADSL modems must reset subnet mask and IP addresses individually before processing the upgrade.

### SUMMARY OF THE INVENTION

Accordingly, the invention provides a method and system for network device upgrade, in which subnet masks of network devices are reset by a computer system issuing an upgrade command.

The system of upgrading network devices according to the present invention comprises a computer system, a switching device and a plurality of network devices.

The computer system outputs a first packet and a second packet. The first packet comprises at least version identification for upgrade data. The second packet comprises at least the upgrade data.

The switching device is connected to the computer system.

The plurality of network devices is connected to the switching device to receive the first and second packets. The plurality of network devices receives the first package to generate non-repetitive IP addresses corresponding to the computer system, wherein the plurality of network devices selectively generates an upgrade request according to the version identification data in the first packet and outputs the request to the computer system.

The method for network device upgrade utilizes a computer system and a plurality of network devices connected thereto. First, the computer system outputs a first package to the plurality of network devices, comprising at least version identification corresponding to upgrade data. After receiving the first package, the plurality of network devices generates non-repetitive IP addresses corresponding to the computer system. Thereafter, the plurality of network devices selectively generates an upgrade request and outputs the request to the computer system according to the version identification data of the upgrade data. Then, the computer system outputs a second package comprising the upgrade data to the plurality of network devices according to IP addresses thereof, after which the plurality of network devices outputs an upgrade request to the computer system. Finally, the plurality of network devices executes upgrade utilizing the upgrade data in the second package.

The invention provides another method for network device upgrade for a network device utilizing an external computer system. First, the network device receives a first package comprising at least version identification corresponding to upgrade data. Then, the network device generates an IP address according to the first package and a media access control address of the network device, the IP address corresponding to subnet of the computer system. Thereafter, the network device generates an upgrade request according to the version identification data of the first package, and outputs the request to the computer system. Then, the network device receives a second package comprising at least upgrade data. The network device generates upgrade data according to comparison between the upgrade data in the second package and existing data from the network device. Finally, the network device writes new firmware according to the upgrade data to flash memory.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the architecture of the system for network device upgrade;

FIG. 2 is a schematic view showing an indicator light system of the network device;

FIG. 3 is a flowchart illustrating the method for network device upgrade;

FIG. 4 is a schematic view showing the first package;

FIG. 5 is a schematic view showing the IP address.

### DETAILED DESCRIPTION OF THE INVENTION

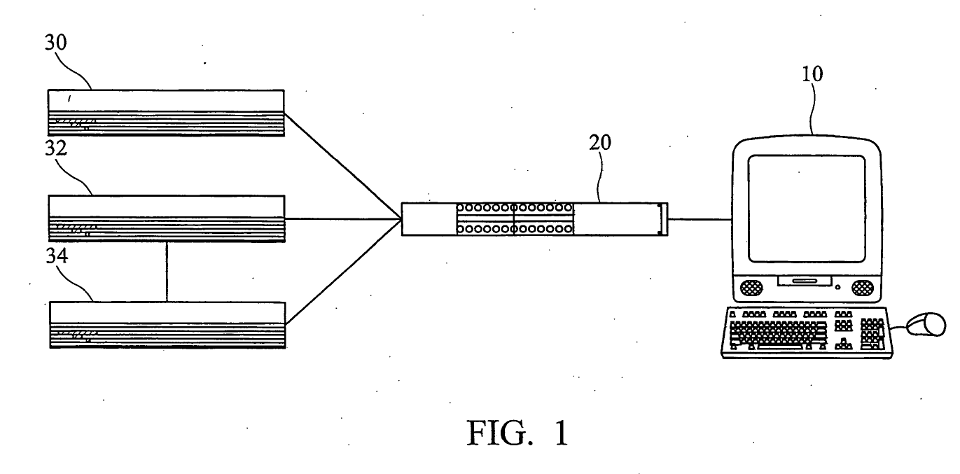

FIG. 1 is a schematic diagram showing the architecture of the system for network device upgrade.

The system includes a computer system 10, network devices 30, 32, 34, and a switching device 20.

The computer system 10 outputs a first package and a second package. The first package comprises at least version identification for upgrade data. The second package comprises at least the upgrade data.

Network devices 30, 32, 34, TCP/IP protocol network devices, receive the first package and generate non-repetitive IP addresses corresponding to the computer system. Network devices 30, 32, 34 generate an upgrade request according to the version identification data and output the upgrade request to the computer system 10. Network devices 30, 32, 34 check a signature of the second package for validity. Network devices 30, 32, 34 compare the update data and existing data to generate upgrade data, and generate new firmware according thereto, which is then written to flash memory. The computer system 10 receives the upgrade request, and outputs the second package to network devices 30, 32, 34 according to IP addresses thereof.

The switching device 20 is connected to the computer system 10 and network devices 30, 32, 34. The switching device 20 has several ports supporting TCP/IP protocol.

Network devices 30, 32, 34, via the switching device 20, connect to the computer system 10. The computer system 10, utilizing the switch, outputs the first package and the second package to network devices 30, 32, 34. Network devices 30, 32, 34, via the switching device 20, receive the first package and the second package.

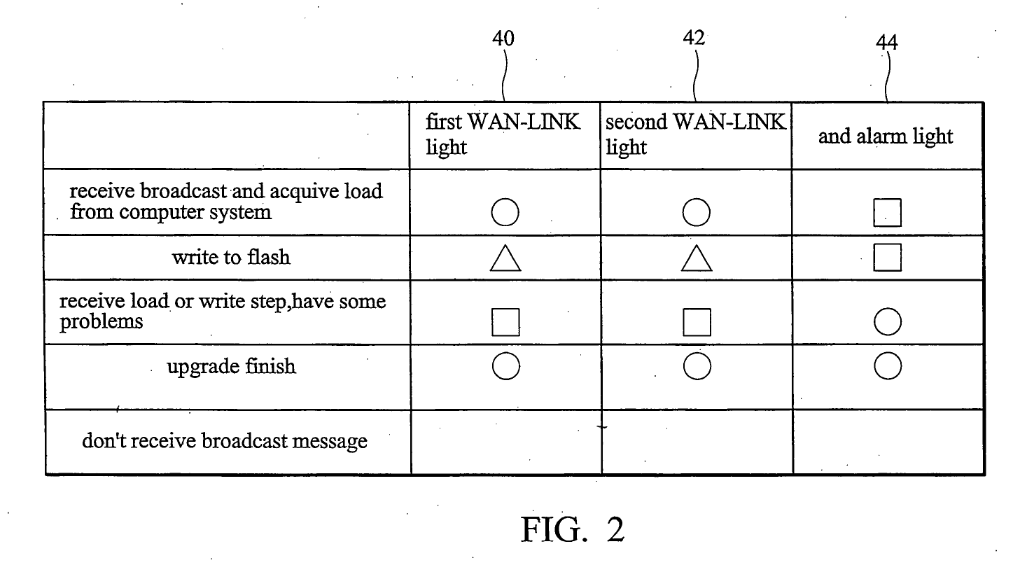

FIG. 2 is a schematic view of an indicator light system of the network device, comprising a first WAN-LINK light 40, a second WAN-LINK light 42 and an alarm light 44.

Network devices 30, 32, 34 utilize indicator lights to report upgrade progress. The first WAN-LINK light 40 indicates successful connection between network devices 30, 32, 34 and the switching device 20. The second WAN-LINK light 42 indicates successful connection between a network card of the computer system 10 and the switching device 20. The alarm light 44 indicates connection failure. In FIG. 2 a circle represents constant light, a triangle flashing light, and a square no light.

The computer system 10 via the switching device 20 outputs a first package comprising an upgrade command, indicated by first WAN-LINK light 40 and second WAN-LINK light 42 being lit and alarm light 44 not lit, since network devices 30, 32, 34, via file transfer protocol, have received the upgrade command.

Indicator lights of network device 30, 32, 34 do not light when output of the upgrade command is unsuccessful.

The computer system 10 receives the upgrade request, and the switching device 20 outputs the second package, comprising upgrade data, according to IP addresses of the network devices. The first WAN-LINK light 40 and the second WAN-LINK light 42 are lit but the alarm light 44 is not when the network devices 30, 32, 34 receive the upgrade data.

Network devices 30, 32, 34 individually generate new firmware according to the upgrade data, and write the new firmware to flash memory of network devices 30, 32, 34. The first WAN-LINK light 40 and the second WAN-LINK light 42 flash and the alarm light 44 is out, accordingly. The first WAN-LINK light 40, the second WAN-LINK light 42 and the alarm light 44 are off at completion of the upgrade.

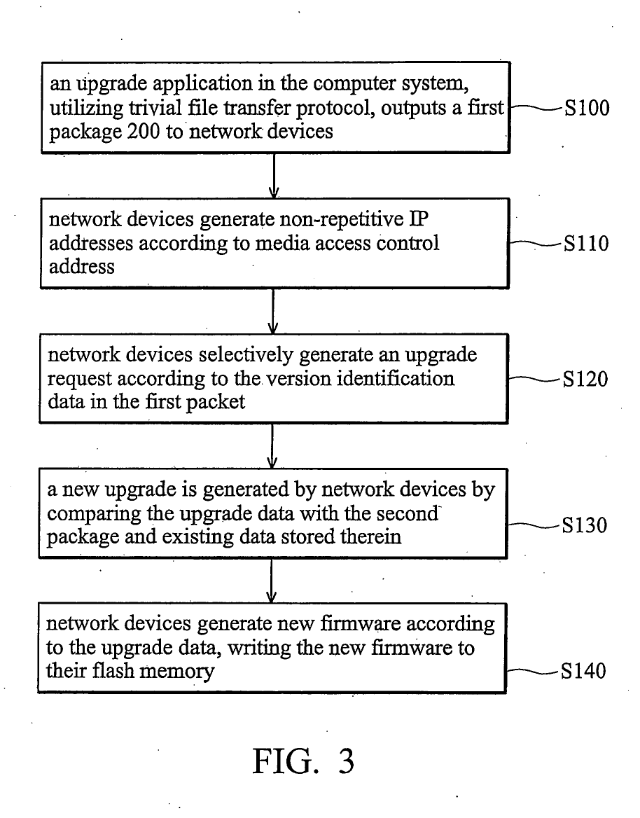

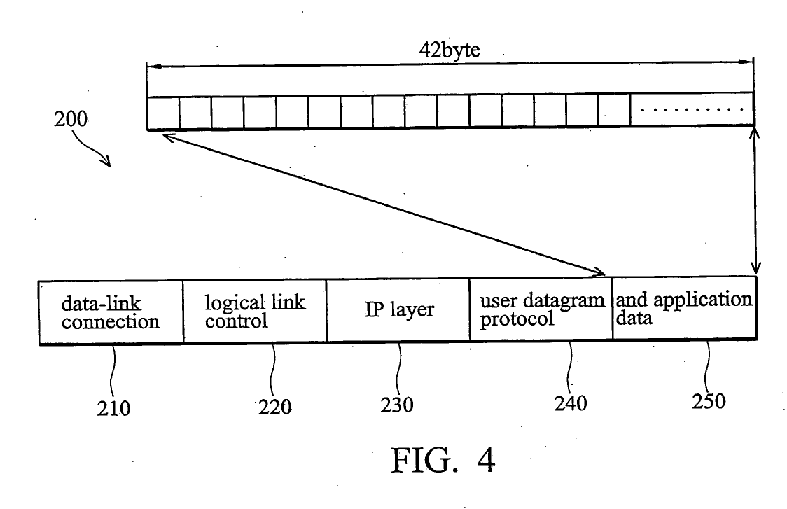

FIG. 3 is a flowchart illustrating the method for network device upgrade. FIG. 4 is a schematic view showing the first package.

First, in step S100, an upgrade application in the computer system, utilizing trivial file transfer protocol, outputs a first package 200 to network devices. The first package 200 comprises a data-link connection 210 (DLC), a logical link control 220 (LLC), an IP layer 230, a user datagram protocol 240 (UDP) and application data 250, wherein the IP layer 230 comprises a destination IP address, and the user datagram protocol 240 comprises a destination port. The application data 250 is 42b and comprises identification data.

In step S110, network devices generate non-repetitive IP addresses according to media access control address. Network devices receive the first package, and check the number of bytes of the first package and destination port. Network devices individually generate a subnet mask and a routing table corresponding to the computer system.

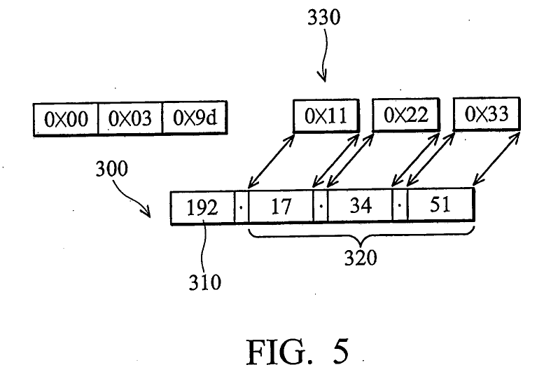

FIG. 5 is a schematic view showing the IP address. The IP address 300 comprises an immobile part 310 and an alteration part 320. The IP address 300 is 192.17.34.51. The alteration part 320 (17.34.51) of the IP address 300 is generated according to media access control address (0×11, 0×22, 0×33) of a network device. The immobile part 310 of the IP address 300 is 192.

In step S120, network devices selectively generate an upgrade request according to the version identification data in the first packet, generate the upgrade request according to a file name in the version identification data, and, utilizing file transfer protocol, output the request data to the computer system. The computer system outputs a second package, comprising upgrade data, to network devices according to IP addresses thereof.

In step S130, a new upgrade is generated by network devices by comparing the upgrade data with the second package and existing data stored therein.

Finally, in step S140, network devices generate new firmware according to the upgrade data, writing the new firmware to their flash memory. Network devices utilizing the new firmware only upgrade blocks differing between the upgrade data and the existing data.

The present invention provides a system and method for network device upgrade. A computer system updates IP addresses and subnet masks of network devices, making the upgrade more convenient and efficient and reducing costs for the factory and research and development department.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for network device upgrade, comprising:
a computer system for outputting a first packet and a second packet, the first packet comprising at least version identification for upgrade data, and the second packet comprising at least the upgrade data;
a switching device connected to the computer system;
a plurality of network devices connected to the switching device to receive the first and second packets, receiving the first package to individually generate non-repetitive IP addresses corresponding to the computer system, selectively generating an upgrade request according to the version identification data in the first packet, and outputting an upgrade request to the computer system;
wherein the computer system receives the upgrade request, and outputs the second package according to the IP addresses of the plurality of network devices, by which the plurality of network devices is upgraded.

2. The system as claimed in claim 1, wherein the plurality of network devices receives the second package, compares the upgrade data therein with existing stored data, and generates new firmware according thereto, writing the update to flash memory.

3. The system as claimed in claim 1, wherein an IP address comprises an immobile part and an alteration part, the immobile part decided by a media access control address of a network device, the immobile part corresponding to a subnet of the computer system.

4. The system as claimed in claim 1, wherein the plurality of network devices receives the first package to generate a subnet mask and a routing table, the subnet mask and the routing table corresponding to the computer system.

5. The system as claimed in claim 1, wherein the plurality of network devices comprises TCP/IP protocol network devices.

6. The system as claimed in claim 1, wherein the computer system outputs the first package to the plurality of network devices.

7. The system as claimed in claim 1, wherein version identification data of the upgrade data comprises a file name of the upgrade data.

8. A method for network device upgrade utilizing a computer system with a plurality of network devices connected thereto, comprising the steps of:
outputting a first package from the computer system to the plurality of network devices, comprising at least version identification corresponding to upgrade data;
receiving the first package utilizing the plurality of network devices, wherein the plurality of network devices generate non-repetitive IP addresses corresponding to the computer system;
selectively generating an upgrade request and outputting the upgrade request to the computer system for utilizing the plurality of network devices according to the version identification data of the upgrade data;
outputting a second package comprising upgrade data to the plurality of network devices according to IP addresses thereof, the plurality of network devices then outputting an upgrade request to the computer system; and
upgrading the plurality of network devices completely according to the upgrade data in the second package.

9. The method as claimed in claim 8, wherein the plurality of network devices compares the update data and existing data stored therein to generate upgrade data, generate new firmware according to the upgrade data, and writes the new firmware to flash memory.

10. The method as claimed in claim 8, further comprising checking a length of the version identification data of upgrade data.

11. The method as claimed in claim 8, wherein an IP address comprises an immobile part and an alteration part, the immobile part decided by a media access control address of the network device, and the immobile part corresponding to a subnet of the computer system.

12. The method as claimed in claim 8, wherein in the plurality of network devices generate a subnet mask and a routing table, and the subnet mask and the routing table corresponding to the computer system.

13. The method as claimed in claim 8, wherein the plurality of network devices are TCP/IP protocol network device.

14. The method as claimed in claim 8, wherein the computer system outputs the first package to the plurality of network devices.

15. The method as claimed in claim 8, wherein comprising checking a signature of the second package for validity.

16. The method as claimed in claim 8, wherein the version identification data of the upgrade data comprises a file name of the upgrade data.

17. A method for network device upgrade for a network device utilizing an external computer system executing the upgrade, comprising the steps of:
receiving a first package, comprising at least version identification corresponding to upgrade data;
generating an IP address according to the first package and a media access control address of the network device, the IP address corresponding to a subnet of the computer system;
generating an upgrade request according to the version identification data of the first package, and outputting the upgrade request;
receiving a second package comprising at least upgrade data;
generating upgrade data according to comparison of the upgrade data of the second package and existing data from the network device; and
writing new firmware to flash memory, the new firmware generated according to existing data.

18. The method as claimed in claim 17, further comprising checking the file size of the version identification of the upgrade data.

19. The method as claimed in claim 17, wherein the IP address comprises an immobile part and an alteration part, the immobile part decided by a media access control address of the network device, and the immobile part corresponding to a subnet of the computer system.

20. The method as claimed in claim 17, further comprising generating a subnet mask and a routing table, both corresponding to the computer system.
